(19) United States
(12) Patent Application Publication
(10) Pub. No.: US 2004/0170849 A1
(43) Pub. Date: Sep. 2, 2004

(54) Thermal barrier coating protected by infiltrated alumina and method for preparing same

(76) Inventors: John Frederick Ackerman, Laramie, WY (US); Bangalore Aswatha Nagaraj, West Chester, OH (US); Brett Allen Boutwell, Liberty Township, OH (US)

Correspondence Address: HASSE GUTTAG & NESBITT LLC, 7550 CENTRAL PARK BLVD., MASON, OH, 45040, US

(21) Appl. No.: 10/797,422

(22) Filed: Mar. 10, 2004

Related U.S. Application Data
(62) Division of application No. 10/317,758, filed on Dec. 12, 2002.

(51) Int. Cl. B32B 15/04; B05D 1/36; B05D 3/02

(52) U.S. Cl. 428/472; 428/469; 416/241 B; 428/307.7; 427/404; 427/419.1; 427/376.1

(57) ABSTRACT

A thermal barrier coating for an underlying metal substrate of articles that operate at, or are exposed to, high temperatures, as well as being exposed to environmental contaminant compositions. This coating includes a porous outer layer having an exposed surface and comprising a non-alumina ceramic thermal barrier coating material, as well as alumina infiltrated within the porous outer layer in an amount sufficient to protect the coating at least partially against environmental contaminants that become deposited on the exposed surface. This coating can be used to provide a thermally protected article having a metal substrate and optionally a bond coat layer adjacent to and overlaying the metal substrate. The thermal barrier coating can be infiltrated with the alumina by treating the porous outer layer with a liquid composition comprising an alumina precursor and then converting the infiltrated alumina precursor to alumina.

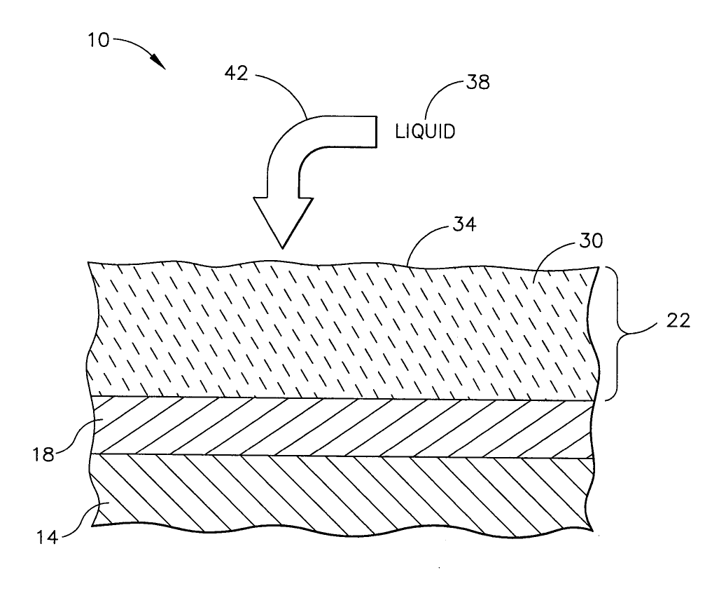

### BACKGROUND OF THE INVENTION

The present invention relates to thermal barrier coatings containing infiltrated alumina for protection and mitigation against environmental contaminants, in particular oxides of calcium, magnesium, aluminum, silicon, and mixtures thereof that can become deposited onto such coatings. The present invention further relates to articles with such coatings and a method for preparing such coatings for the article.

Thermal barrier coatings are an important element in current and future gas turbine engine designs, as well as other articles that are expected to operate at or be exposed to high temperatures, and thus cause the thermal barrier coating to be subjected to high surface temperatures. Examples of turbine engine parts and components for which such thermal barrier coatings are desirable include turbine blades and vanes, turbine shrouds, buckets, nozzles, combustion liners and deflectors, and the like. These thermal barrier coatings are deposited onto a metal substrate (or more typically onto a bond coat layer on the metal substrate for better adherence) from which the part or component is formed to reduce heat flow and to limit the operating temperature these parts and components are subjected to. This metal substrate typically comprises a metal alloy such as a nickel, cobalt, and/or iron based alloy (e.g., a high temperature superalloy).

The thermal barrier coating usually comprises a ceramic material, such as a chemically (metal oxide) stabilized zirconia. Examples of such chemically stabilized zirconias include yttria-stabilized zirconia, scandia-stabilized zirconia, calcia-stabilized zirconia, and magnesia-stabilized zirconia. The thermal barrier coating of choice is typically a yttria-stabilized zirconia ceramic coating. A representative yttria-stabilized zirconia thermal barrier coating usually comprises about 7% yttria and about 93% zirconia. The thickness of the thermal barrier coating depends upon the metal substrate part or component it is deposited on, but is usually in the range of from about 3 to about 70 mils (from about 75 to about 1795 microns) thick for high temperature gas turbine engine parts.

Under normal conditions of operation, thermal barrier coated metal substrate turbine engine parts and components can be susceptible to various types of damage, including erosion, oxidation, and attack from environmental contaminants. At the higher temperatures of engine operation, these environmental contaminants can adhere to the heated or hot thermal barrier coating surface and thus cause damage to the thermal barrier coating. For example, these environmental contaminants can form compositions that are liquid or molten at the higher temperatures that gas turbine engines operate at. These molten contaminant compositions can dissolve the thermal barrier coating, or can infiltrate its porous structure, i.e., can infiltrate the pores, channels or other cavities in the coating. Upon cooling, the infiltrated contaminants solidify and reduce the coating strain tolerance, thus initiating and propagating cracks that cause delamination, spalling and loss of the thermal barrier coating material either in whole or in part.

These pores, channel or other cavities that are infiltrated by such molten environmental contaminants can be created by environmental damage, or even the normal wear and tear that results during the operation of the engine. However, this porous structure of pores, channels or other cavities in the thermal barrier coating surface more typically is the result of the processes by which the thermal barrier coating is deposited onto the underlying bond coat layer-metal substrate. For example, thermal barrier coatings that are deposited by (air) plasma spray techniques tend to create a sponge-like porous structure of open pores in at least the surface of the coating. By contrast, thermal barrier coatings that are deposited by physical (e.g., chemical) vapor deposition techniques tend to create a porous structure comprising a series of columnar grooves, crevices or channels in at least the surface of the coating. This porous structure can be important in the ability of these thermal barrier coating to tolerate strains occurring during thermal cycling and to reduce stresses due to the differences between the coefficient of thermal expansion (CTE) of the coating and the CTE of the underlying bond coat layer/substrate.

For turbine engine parts and components having outer thermal barrier coatings with such porous surface structures, environmental contaminant compositions of particular concern are those containing oxides of calcium, magnesium, aluminum, silicon, and mixtures thereof. See, for example, U.S. Pat. No. 5,660,885 (Hasz et al), issued Aug. 26, 1997 which describes these particular types of oxide environmental contaminant compositions. These oxides combine to form contaminant compositions comprising mixed calcium-magnesium-aluminum-silicon-oxide systems (Ca—Mg—Al—SiO), hereafter referred to as “CMAS.” During normal engine operations, CMAS can become deposited on the thermal barrier coating surface, and can become liquid or molten at the higher temperatures of normal engine operation. Damage to the thermal barrier coating typically occurs when the molten CMAS infiltrates the porous surface structure of the thermal barrier coating. After infiltration and upon cooling, the molten CMAS solidifies within the porous structure. This solidified CMAS causes stresses to build within the thermal barrier coating, leading to partial or complete delamination and spalling of the coating material, and thus partial or complete loss of the thermal protection provided to the underlying metal substrate of the part or component.

Accordingly, it would be desirable to protect these thermal barrier coatings having a porous surface structure against the adverse effects of such environmental contaminants when used with a metal substrate for a turbine engine part or component, or other article, operated at or exposed to high temperatures. In particular, it would be desirable to be able to protect such thermal barrier coatings from the adverse effects of deposited CMAS.

### BRIEF DESCRIPTION OF THE INVENTION

The present invention relates to a thermal barrier coating for an underlying metal substrate of articles that operate at, or are exposed to, high temperatures, as well as being exposed to environmental contaminant compositions, in particular CMAS. This thermal barrier coating comprises:

a. a porous outer layer having an exposed surface and comprising a non-alumina ceramic thermal barrier coating material in an amount up to 100%; and

b. alumina infiltrated within the outer layer in an amount sufficient to protect the thermal barrier coating at least partially against environmental contaminants that become deposited on the exposed surface.

The present invention also relates to a thermally protected article.

This protected article comprises:

a. a metal substrate;

b. optionally a bond coat layer adjacent to and overlaying the metal substrate; and

c. a thermal barrier coating as previously described adjacent to and overlaying the bond coat layer (or overlaying the metal substrate if the bond coat layer is absent).

The present invention further relates to a method for preparing the thermal barrier coating protected by such infiltrated alumina. This method comprises the steps of:

1. providing a thermal barrier coating overlaying the metal substrate, the thermal barrier coating including a porous outer layer having an exposed surface and comprising a non-alumina ceramic thermal barrier coating material in an amount up to 100%;

2. treating the outer layer with a liquid composition comprising an alumina precursor to infiltrate the outer layer with the alumina precursor in an amount sufficient to provide, when converted to alumina, at least partial protection of the thermal barrier coating against environmental contaminants that become deposited on the exposed surface; and

3. converting the infiltrated alumina precursor within the outer layer to alumina.

The thermal barrier coating of the present invention is provided with at least partial and up to complete protection and mitigation against the adverse effects of environmental contaminant compositions that can deposit on the surface of such coatings during normal turbine engine operation. In particular, the thermal barrier coating of the present invention is provided with at least partial and up to complete protection or mitigation against the adverse effects of CMAS deposits on such coating surfaces. The infiltrated alumina within the porous outer layer of the thermal barrier coating usually combines with these CMAS deposits and thus typically raises the melting point of such deposits sufficiently so that the deposits do not become molten, or alternatively increases the viscosity of such molten deposits so that they do not flow readily, at higher temperatures normally encountered during turbine engine operation. As a result, these CMAS deposits are unable to infiltrate the normally porous surface structure of the thermal barrier coating, and thus cannot cause undesired partial (or complete) delamination and spalling of the coating.

The method of the present invention provides an effective and efficient way to infiltrate the porous outer layer of the thermal barrier coating with a protective amount of alumina. In addition, the thermal barrier coatings of the present invention are provided with protection or mitigation, in whole or in part, against the infiltration of corrosive (e.g., alkali) environmental contaminant deposits. The thermal barrier coatings of the present invention are also useful with worn or damaged coated (or uncoated) metal substrates of turbine engine parts and components in providing protection or mitigation against the adverse effects of such environmental contaminate compositions, e.g., to provide refurbished parts and components. In addition to turbine engine parts and components, the thermal barrier coatings of the present invention are useful for metal substrates of other articles that operate at, or are exposed, to high temperatures, as well as to such environmental contaminate compositions.

### BRIEF DESCRIPTION OF THE DRAWINGS

The FIG. is a side sectional view illustrating an embodiment of the method of the present invention for preparing a thermal barrier coating and coated article.

### DETAILED DESCRIPTION OF THE INVENTION

As used herein, the term “CMAS” refers environmental contaminant compositions that contain oxides of calcium, magnesium, aluminum, silicon, and mixtures thereof. These oxides typically combine to form compositions comprising calcium-magnesium-aluminum-silicon-oxide systems (Ca—Mg—Al—SiO).

As used herein, the terms “alumina” and “aluminum oxide” refer interchangeably to those compounds and compositions comprising Al₂O₃, including unhydrated and hydrated forms.

As used herein, the term “non-alumina thermal barrier coating material” refers to those coating materials (other than alumina) that are capable of reducing heat flow to the underlying metal substrate of the article, i.e., forming a thermal barrier. These materials usually have a melting point of at least about 2000° F. (1093° C.), typically at least about 2200° F. (1204° C.), and more typically in the range of from about 2200° to about 3500° F. (from about 1204° to about 1927° C.). Suitable non-alumina ceramic thermal barrier coating materials include various zirconias, in particular chemically stabilized zirconias (i.e., various metal oxides such as yttrium oxides blended with zirconia), such as yttria-stabilized zirconias, ceria-stabilized zirconias, calcia-stabilized zirconias, scandia-stabilized zirconias, magnesia-stabilized zirconias, india-stabilized zirconias, ytterbia-stabilized zirconias as well as mixtures of such stabilized zirconias. See, for example, Kirk-Othmer's Encyclopedia of Chemical Technology, 3rd Ed., Vol. 24, pp. 882-883 (1984) for a description of suitable zirconias. Suitable yttria-stabilized zirconias can comprise from about 1 to about 20% yttria (based on the combined weight of yttria and zirconia), and more typically from about 3 to about 10% yttria. These chemically stabilized zirconias can further include one or more of a second metal (e.g., a lanthanide or actinide) oxide such as dysprosia, erbia, europia, gadolinia, neodymia, praseodymia, urania, and hafnia to further reduce thermal conductivity of the thermal barrier coating. See U.S. Pat. No. 6,025,078 (Rickersby et al), issued Feb. 15, 2000 and U.S. Pat. No. 6,333,118 (Alperine et al), issued Dec. 21, 2001, both of which are incorporated by reference. Suitable non-alumina ceramic thermal barrier coating materials also include pyrochlores of general formula A₂B₂O₇ where A is a metal having a valence of 3+ or 2+(e.g., gadolinium, aluminum, cerium, lanthanum or yttrium) and B is a metal having a valence of 4+ or 5+(e.g., hafnium, titanium, cerium or zirconium) where the sum of the A and B valences is 7. Representative materials of this type include gadolinium-zirconate, lanthanum titanate, lanthanum zirconate, yttrium zirconate, lanthanum hafnate, cerium zirconate, aluminum cerate, cerium hafnate, aluminum hafnate and lanthanum cerate. See U.S. Pat. No. 6,117,560 (Maloney), issued Sep. 12, 2000; U.S. Pat. No. 6,177,200 (Maloney), issued Jan. 23, 2001; U.S. Pat. No. 6,284,323 (Maloney), issued Sep. 4, 2001; U.S. Pat. No. 6,319,614 (Beele), issued Nov. 20, 2001; and U.S. Pat. No. 6,87,526 (Beele), issued May 14, 2002, all of which are incorporated by reference.

As used herein, the term “comprising” means various compositions, compounds, components, layers, steps and the like can be conjointly employed in the present invention. Accordingly, the term “comprising” encompasses the more restrictive terms “consisting essentially of” and “consisting of.”

All amounts, parts, ratios and percentages used herein are by weight unless otherwise specified.

The thermal barrier coatings of the present invention are useful with a wide variety of turbine engine (e.g., gas turbine engine) parts and components that are formed from metal substrates comprising a variety of metals and metal alloys, including superalloys, and are operated at, or exposed to, high temperatures, especially higher temperatures that occur during normal engine operation. These turbine engine parts and components can include turbine airfoils such as blades and vanes, turbine shrouds, turbine nozzles, combustor components such as liners and deflectors, augmentor hardware of gas turbine engines and the like. The thermal barrier coatings of the present invention can also cover a portion or all of the metal substrate. For example, with regard to airfoils such as blades, the thermal barrier coatings of the present invention are typically used to protect, cover or overlay portions of the metal substrate of the airfoil other than solely the tip thereof, e.g., the thermal barrier coatings cover the leading and trailing edges and other surfaces of the airfoil. While the following discussion of the thermal barrier coatings of the present invention will be with reference to metal substrates of turbine engine parts and components, it should also be understood that the thermal barrier coatings of the present invention are useful with metal substrates of other articles that operate at, or are exposed to, high temperatures, as well as being exposed to environmental contaminant compositions, including those the same or similar to CMAS.

The thermal barrier coatings of the present invention, and especially the method for preparing same, are further illustrated by reference to the drawings as described hereafter. Referring to the drawings, the FIG. shows a side sectional view of an embodiment of the thermally barrier coating of the present invention used with the metal substrate of an article indicated generally as 10. As shown in the FIG., article 10 has a metal substrate indicated generally as 14. Substrate 14 can comprise any of a variety of metals, or more typically metal alloys, that are typically protected by thermal barrier coatings, including those based on nickel, cobalt and/or iron alloys. For example, substrate 14 can comprise a high temperature, heat-resistant alloy, e.g., a superalloy. Such high temperature alloys are disclosed in various references, such as U.S. Pat. No. 5,399,313 (Ross et al), issued Mar. 21, 1995 and U.S. Pat. No. 4,116,723 (Gell et al), issued Sep. 26, 1978, both incorporated herein by reference. High temperature alloys are also generally described in Kirk-Othmer's Encyclopedia of Chemical Technology, 3rd Ed., Vol. 12, pp. 417-479 (1980), and Vol. 15, pp. 787-800 (1981). Illustrative high temperature nickel-based alloys are designated by the trade names Inconel®, Nimonicg, Rene® (e.g., Rene® 80-, Rene® 95 alloys), and Udimet®. As described above, the type of substrate 14 can vary widely, but it is representatively in the form of a turbine part or component, such as an airfoil (e.g., blade) or turbine shroud.

As shown in the FIG., article 10 also includes a bond coat layer indicated generally as 18 that is adjacent to and overlies substrate 14. Bond coat layer 18 is typically formed from a metallic oxidation-resistant material that protects the underlying substrate 14 and enables the thermal barrier coating indicated generally as 22 to more tenaciously adhere to substrate 14. Suitable materials for bond coat layer 18 include MCrAlY alloy powders, where M represents a metal such as iron, nickel, platinum or cobalt, in particular, various metal aluminides such as nickel aluminide and platinum aluminide. This bond coat layer 18 can be applied, deposited or otherwise formed on substrate 10 by any of a variety of conventional techniques, such as physical vapor deposition (PVD), including electron beam physical vapor deposition (EBPVD), plasma spray, including air plasma spray (APS) and vacuum plasma spray (VPS), or other thermal spray deposition methods such as high velocity oxy-fuel (HVOF) spray, detonation, or wire spray, chemical vapor deposition (CVD), or combinations of such techniques, such as, for example, a combination of plasma spray and CVD techniques. Typically, a plasma spray technique, such as that used for the thermal barrier coating 22, can be employed to deposit bond coat layer 18. Usually, the deposited bond coat layer 18 has a thickness in the range of from about 1 to about 19.5 mils (from about 25 to about 500 microns). For bond coat layers 18 deposited by PVD techniques such as EBPVD, the thickness is more typically in the range of from about 1 about 3 mils (from about 25 to about 75 microns). For bond coat layers deposited by plasma spray techniques such as APS, the thickness is more typically, in the range of from about 3 to about 15 mils (from about 75 to about 385 microns).

As shown in the FIG., the thermal barrier coating (TBC) 22 is adjacent to and overlies bond coat layer 18. The thickness of TBC 22 is typically in the range of from about 1 to about 100 mils (from about 25 to about 2564 microns) and will depend upon a variety of factors, including the article 10 that is involved. For example, for turbine shrouds, TBC 22 is typically thicker and is usually in the range of from about 30 to about 70 mils (from about 769 to about 1795 microns), more typically from about 40 to about 60 mils (from about 1333 to about 1538 microns). By contrast, in the case of turbine blades, TBC 22 is typically thinner and is usually in the range of from about 1 to about 30 mils (from about 25 to about 769 microns), more typically from about 3 to about 20 mils (from about 77 to about 513 microns).

As shown in the FIG., TBC 22 comprises, in whole or in part, a porous outer layer indicated as 30 having an exposed surface indicated as 34. This porous outer layer 30 comprises a non-alumina ceramic thermal barrier coating material in an amount of up to 100%. Typically, outer layer 30 comprises from about 95 to 100% non-alumina ceramic thermal barrier coating material, and more typically from about 98 to 100% non-alumina ceramic thermal barrier coating material. The composition of outer layer 30 in terms of the type of non-alumina ceramic thermal barrier coating material will depend upon a variety of factors, including the composition of the adjacent bond coat layer 18, the coefficient of thermal expansion (CTE) characteristics for TBC 22, the thermal barrier properties desired for TBC 22, and like factors well known to those skilled in the art. The thickness of outer layer 30 will also depend upon a variety of factors, including the overall desired thickness of TBC 22. Typically, outer layer 30 will comprise from about 95 to 100%, more typically from about 98 to 100%, of the thickness of TBC 22.

The composition and thickness of the bond coat layer 18 and outer layer 30 of TBC 22, are typically adjusted to provide appropriate CTEs to minimize thermal stresses between the various layers and the substrate 14 so that the various layers are less prone to separate from substrate 14 or each other. In general, the CTEs of the respective layers typically increase in the direction of outer layer 30 to bond coat layer 18, i.e., outer layer 30 has the lowest CTE, while bond coat layer 18 has the highest CTE.

Referring to the FIG., porous outer layer 30 of TBC 22 can be applied, deposited or otherwise formed on bond coat layer 18 by any of a variety of conventional techniques, such as physical vapor deposition (PVD), including electron beam physical vapor deposition (EBPVD), plasma spray, including air plasma spray (APS) and vacuum plasma spray (VPS), or other thermal spray deposition methods such as high velocity oxy-fuel (HVOF) spray, detonation, or wire spray; chemical vapor deposition (CVD), or combinations of plasma spray and CVD techniques. The particular technique used for applying, depositing or otherwise forming porous outer layer 30 will typically depend on the composition of porous outer layer 30, its thickness and especially the physical structure desired for TBC 22. For example, PVD techniques tend to be useful in forming TBCs having a porous strain-tolerant columnar structure with grooves, crevices or channels formed in porous outer layer 30. By contrast, plasma spray techniques (e.g., APS) tend to create a sponge-like porous structure of open pores in outer layer 30. Typically, outer layer 30 of TBC 22 is formed by plasma spray techniques in the method of the present invention.

Various types of plasma-spray techniques well known to those skilled in the art can be utilized to apply the non-alumina ceramic thermal barrier coating materials in forming the porous outer layer 30 of TBC 22 of the present invention. See, for example, Kirk-Othmer Encyclopedia of Chemical Technology, 3rd Ed., Vol. 15, page 255, and references noted therein, as well as U.S. Pat. No. 5,332,598 (Kawasaki et al), issued Jul. 26, 1994; U.S. Pat. No. 5,047,612 (Savkar et al) issued Sep. 10, 1991; and U.S. Pat. No. 4,741,286 (Itoh et al), issued May 3, 1998 (herein incorporated by reference) which are instructive in regard to various aspects of plasma spraying suitable for use herein. In general, typical plasma spray techniques involve the formation of a high-temperature plasma, which produces a thermal plume. The non-alumina ceramic thermal barrier coating materials, e.g., ceramic powders, are fed into the plume, and the high-velocity plume is directed toward the bond coat layer 18. Various details of such plasma spray coating techniques are well-known to those skilled in art, including various relevant steps and process parameters such as cleaning of the bond coat surface 18 surface prior to deposition; grit blasting to remove oxides and roughen the surface substrate temperatures, plasma spray parameters such as spray distances (gun-to-substrate), selection of the number of spray-passes, powder feed rates, particle velocity, torch power, plasma gas selection, oxidation control to adjust oxide stoichiometry, angle-of-deposition, post-treatment of the applied coating; and the like. Torch power can vary in the range of about 10 kilowatts to about 200 kilowatts, and in preferred embodiments, ranges from about 40 kilowatts to about 60 kilowatts. The velocity of the thermal barrier coating material particles flowing into the plasma plume (or plasma “jet”) is another parameter which is usually controlled very closely.

Suitable plasma spray systems are described in, for example, U.S. Pat. No. 5,047,612 (Savkar et al) issued Sep. 10, 1991, which is incorporated by reference. Briefly, a typical plasma spray system includes a plasma gun anode which has a nozzle pointed in the direction of the deposit-surface of the substrate being coated. The plasma gun is often controlled automatically, e.g., by a robotic mechanism, which is capable of moving the gun in various patterns across the substrate surface. The plasma plume extends in an axial direction between the exit of the plasma gun anode and the substrate surface. Some sort of powder injection means is disposed at a predetermined, desired axial location between the anode and the substrate surface. In some embodiments of such systems, the powder injection means is spaced apart in a radial sense from the plasma plume region, and an injector tube for the powder material is situated in a position so that it can direct the powder into the plasma plume at a desired angle. The powder particles, entrained in a carrier gas, are propelled through the injector and into the plasma plume. The particles are then heated in the plasma and propelled toward the substrate. The particles melt, impact on the substrate, and quickly cool to form the thermal barrier coating.

In forming the TBCs 22 of the present invention, the porous outer layer 30 is initially formed on bond coat layer 18. In forming outer layer 30, the non-alumina ceramic thermal barrier coating material is typically deposited on the bond coat layer 18. As shown in the FIG., and after the non-alumina ceramic thermal barrier coating material is deposited to form porous outer layer 30, this outer layer 30 is then treated with a liquid composition indicated generally as 38. As also shown in the FIG., treatment can be carried out by pouring, depositing, or otherwise applying liquid composition 38, as indicated by arrow 42, on or to porous outer layer 30.

Liquid composition 38 comprises an alumina precursor that is dissolved or otherwise dispersed in a liquid media. As used in herein, the term “alumina precursor” refers to those aluminum compounds that are capable of being converted to alumina. Suitable alumina precursors include aluminum alkoxides, aluminum β-diketonates, aluminum alkyls, alumina sols, and like alumina precursors well know to those skilled in the art. See, for example, U.S. Pat. No. 4,532,072 (Segal), issued Jul. 30, 1985; U.S. Pat. No. 5,047,174 (Sherif), issued Sep. 10, 1991; U.S. Pat. No. 5,324,544 (Spence et al), issued Jun. 28, 1994; and U.S. Pat. No. 5,591,380 (Wright), issued Jan. 7, 1997, all of which are incorporated by reference. Suitable aluminum alkoxides for use herein include aluminum methoxides, aluminum ethoxides, aluminum propoxides or isopropoxides, aluminum butoxides, aluminum sec-butoxides and mixtures thereof. See U.S. Pat. No. 4,532,072 (Segal), issued Jul. 30, 1985 and U.S. Pat. No. 5,591,380 (Wright), issued Jan. 7, 1997, both of which are incorporated by reference. These alumina precursors, in particular aluminum alkoxides, are usually soluble in water, or in combinations of water and polar organic liquid solvents such as alcohols, e.g., ethanol, methanol, isopropanol, and butanol, aldehydes, ketones, e.g., acetone, and other polar organic solvents, as well as mixtures of polar organic solvents, well known to those skilled in the art. Accordingly, liquid compositions 38 comprising these alumina precursors are typically aqueous compositions, i.e., comprise, in whole or in part, water as the liquid media. The particular amount or concentration of alumina precursor present in liquid composition 38 will depend on a variety of factors, including the type of alumina precursor involved. Typically, liquid composition 38 comprises from about 5 to about 50% alumina precursor, more typically from about 10 to about 20% alumina precursor.

Liquid composition 38 is poured, deposited or otherwise applied on or to porous outer layer 30 in a manner such that the alumina precursor is able to soak in, be absorbed by and infiltrate the porous structure of layer 30. The amount of liquid composition 38 that is poured, deposited or otherwise applied on or to porous outer layer 30 is such that the alumina precursor that infiltrates layer 30 is sufficient to provide, when converted to alumina, at least partial protection of TBC 22 against environmental contaminants that become deposited on the exposed surface 34. The period of time required for sufficient infiltration of the alumina precursor will depend on a variety of factors, including the particular liquid composition 38 used, the concentration of alumina precursor in liquid composition 38, the manner in which liquid composition 38 is applied to porous outer layer 30, the composition and structure of layer 30 and like factors well known to those skilled in the art. Typically, porous outer layer 30 is treated with liquid composition 38 for a period of time in the range from about 0.1 to about 30 minutes, more typically from about 1 to about 5 minutes.

In an embodiment for treating porous outer layer 30 with liquid composition 38 containing the alumina precursor, a suitable container can be filled with liquid composition 38 and then article 10 can be placed in the container such that TBC 22 (and especially outer layer 30) is submerged in liquid composition 38. While submerged (typically at ambient temperatures), the container can be evacuated and held at a pressure of about 1 Torr or less for an appropriate period of time, and then repressurized to atmospheric pressure. This evacuation and pressurization cycle can be repeated one or more times until the desired degree of infiltration of alumina precursor within porous outer layer 30 is achieved. After removal from the container, the treated article 10 is typically allowed dry at ambient temperatures.

After porous outer layer 30 has been treated with liquid composition 38 for a period of time sufficient to permit infiltration of the alumina precursor, the infiltrated alumina precursor within porous outer layer 30 is then converted to alumina. The particular manner in which the infiltrated alumina precursor is converted to alumina will depend on a variety of factors, and particularly the type of alumina precursor used. In the case of aluminum precursors such as aluminum alkoxides, the infiltrated precursor is usually thermally converted in situ to alumina. This is typically achieved by heating the infiltrated aluminum alkoxide to a temperature of at least about 1200° F. (649° C.), more typically in the range of from about 1200° to about 1500° F. (from about 649° to about 833° C.), for a sufficient period of time to convert the infiltrated aluminum alkoxide to alumina, typically for at least about 2 hr., more typically for at least about 4 hr. Aluminum alkoxides that are thermally heated are typically converted to the form of finely divided alpha alumina.

This infiltrated alumina within porous outer layer 30 protects TBC 22 by combining with CMAS that deposits itself on exposed surface 34. This combined product typically raises the melting point of such CMAS deposits sufficiently so that the CMAS deposits do not become molten, or alternatively increases the viscosity of such molten deposits so that they do not flow readily, at higher temperatures, e.g., those normally encountered during turbine engine operation. As a result, these CMAS deposits are unable to infiltrate TBC 22 much beyond exposed surface 34.

The method of the present invention is particularly useful in providing protection or mitigation against the adverse effects of such environmental contaminate compositions for TBCs used with metal substrates of newly manufactured articles. However, the method of the present invention is also useful in providing such protection or mitigation against the adverse effects of such environmental contaminate compositions for refurbished worn or damaged TBCs, or in providing TBCs having such protection or mitigation for articles that did not originally have a TBC. For example, a liquid composition 38 comprising the alumina precursor could be applied to such worn or damaged TBCs while the turbine engine component or part is in an assembled state, with the infiltrated TBC being heated or cured to convert the alumina precursor (in situ) to alumina.

### EXAMPLES

### Example 1

The following illustrates an embodiment of the method of the present invention for infiltrating a TBC comprising a porous layer of yttria-stabilized zirconia with alumina by using an aluminum alkoxide:

The parts to be infiltrated with the alumina each comprise a metal substrate consisting of an N-5 nickel superalloy, a NiCrAlY bond coat having a thickness of 7 mils (179.5 microns) adhered to the metal substrate, and a TBC having a thickness of 20 mils (512.8 microns) adhered to the bond coat. The TBC comprises a porous outer layer of yttria-stabilized zirconia.

A solution comprising 15% aluminum isopropoxide/85% ethanol is placed in a vacuum cell, followed by the TBC coated parts which are immersed in the solution. A vacuum of 500 mTorr is applied to the contents of the cell for 5 minutes, followed by pressurization of the cell to 760 Torr by admitting 1 atmosphere of air. This vacuum/pressurization cycle is repeated two additional times to insure that all internal pores of the porous outer layer of the TBC coating are wetted with the aluminum isopropoxide solution. The parts infiltrated with the aluminum isopropoxide solution are removed from the cell and allowed to dry at ambient conditions for two hours. After drying, the parts are placed in a high temperature furnace and heated to 1292° F. (700° C.) for four hours to convert the infiltrated aluminum isopropoxide within the porous outer layer of the TBC to alumina. The alumina obtained is finely divided alpha alumina adherent to the pore walls of the TBC.

### Example 2

A TBC is infiltrated with alumina under the same conditions as Example 1 but using instead a 15% aluminum sec-butoxide in 85% ethanol treatment solution.

While specific embodiments of the method of the present invention have been described, it will be apparent to those skilled in the art that various modifications thereto can be made without departing from the spirit and scope of the present invention as defined in the appended claims.

What is claimed is:

1. A thermal barrier coating for an underlying metal substrate, which comprises:
a. a porous outer layer having an exposed surface and comprising a non-alumina ceramic thermal barrier coating material in an amount up to 100%; and
b. alumina infiltrated within the outer layer in an amount sufficient to protect the thermal barrier coating at least partially against environmental contaminants that become deposited on the exposed surface.

2. The coating of claim 1 which has a thickness of from about 1 to about 100 mils and wherein the outer layer comprises from about 95 to 100% of the thickness of the coating.

3. The coating of claim 2 wherein the outer layer comprises from about 98 to 100% of the thickness of the coating.

4. The coating of claim 2 wherein the outer layer comprises from about 95 to 100% of a zirconia.

5. The coating of claim 4 wherein the outer layer comprises from about 98 to 100% of a yttria-stabilized zirconia.

6. The coating of claim 2 wherein the infiltrated alumina is finely divided alpha alumina.

7. A thermally protected article, which comprises:
1. a metal substrate; and
2. a thermal barrier coating comprising:
a. a porous outer layer overlaying the metal substrate, the outer layer having an exposed surface and comprising a non-alumina ceramic thermal barrier coating material; and
b. alumina infiltrated within the outer layer in an amount sufficient to protect the thermal barrier coating at least partially against environmental contaminants that become deposited on the exposed surface.

8. The article of claim 7 which further comprises a bond coat layer adjacent to and overlaying the metal substrate and wherein the outer layer is adjacent to and overlies the bond coat layer.

9. The article of claim 8 wherein the thermal barrier coating has a thickness of from about 1 to about 100 mils and wherein the outer layer comprises from about 95 to 100% of the thickness of the thermal barrier coating.

10. The article of claim 9 wherein the outer layer comprises from about 98 to 100% of the thickness of the thermal barrier coating.

11. The article of claim 9 wherein the outer layer comprises from about 95 to 100% of a zirconia.

12. The coating of claim 11 wherein the outer layer comprises from about 98 to 100% of a yttria-stabilized zirconia.

13. The article of claim 9 wherein the infiltrated alumina is finely divided alpha alumina.

14. The article of claim 9 which is a turbine engine component.

15. The component of claim 14 which is a turbine shroud and wherein the thermal barrier coating has a thickness of from about 30 to about 70 mils.

16. The shroud of claim 15 wherein the thermal barrier coating has a thickness of from about 40 to about 60 mils.

17. A method for preparing a thermal barrier coating protected by infiltrated alumina that overlies a metal substrate, the method comprising the steps of:
1. providing a thermal barrier coating overlaying a metal substrate, the thermal barrier coating including a porous outer layer having an exposed surface and comprising a non-alumina ceramic thermal barrier coating material in an amount up to 100%;
2. treating the outer layer with a liquid composition comprising an alumina precursor to infiltrate the outer layer with the alumina precursor in an amount sufficient to provide, when converted to alumina, at least partial protection of the thermal barrier coating against environmental contaminants that become deposited on the exposed surface; and
3. converting the infiltrated alumina precursor within the outer layer to alumina.

18. The method of claim 17 wherein a bond coat layer is adjacent to and overlies the metal substrate of step (1) and wherein the outer layer is formed on the bond coat layer.

19. The method of claim 18 wherein the liquid composition comprises from about 5 to about 50% alumina precursor.

20. The method of claim 19 wherein the liquid composition comprises from about 10 to about 20% alumina precursor.

21. The method of claim 19 wherein the alumina precursor is selected from the group consisting of aluminum alkoxides, aluminum β-diketonates, aluminum alkyls and alumina sols.

22. The method of claim 21 wherein the alumina precursor is an aluminum alkoxide selected from the group consisting of aluminum methoxides, aluminum ethoxides, aluminum propoxides, aluminum isopropoxides, aluminum butoxides, aluminum sec-butoxides and mixtures thereof.

23. The method of claim 22 wherein step (3) comprises thermally converting the infiltrated aluminum alkoxide to alumina.

24. The method of claim 23 wherein step (3) comprises heating the infiltrated aluminum alkoxide to a temperature of at least about 1200° F. for a period of at least about 2 hours.

25. The method of claim 24 wherein step (3) comprises heating the infiltrated aluminum alkoxide to a temperature of from about 1200° to about 1500° F. for a period of at least about 4 hours.

26. The method of claim 23 wherein the infiltrated aluminum alkoxide is thermally converted to finely divided alpha alumina.

27. The method of claim 22 wherein the liquid composition is an aqueous composition.

28. The method of claim 27 wherein the liquid composition further comprises a polar organic liquid solvent selected from the group consisting of alcohols, aldehydes, ketones and mixtures thereof.

29. The method of claim 19 wherein the outer layer is treated with the liquid composition for a period of from about 0.1 to about 30 minutes.

30. The method of claim 29 wherein the outer layer is treated with the liquid composition for a period of from about 1 to about 5 minutes.

31. The method of claim 17 wherein the thermal barrier coating of step (1) overlies a metal substrate of a turbine component and wherein the outer layer is treated with the liquid composition during step (2) while the turbine component is in an assembled state.
